(19) United States
(12) Patent Application Publication
(10) Pub. No.: US 2006/0139334 A1
(43) Pub. Date: Jun. 29, 2006

(54) Interactive display system

(76) Inventors: Martinus H W M Van Delden, Eindhoven (NL); Andrea Giraldo, Eindhoven (NL); Hjalmar Edzer Ayco Huitema, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/545,328

(22) PCT Filed: Jan. 29, 2004
(86) PCT No.: PCT/IB04/50064

§ 371 Date: Aug. 10, 2005

(30) Foreign Application Priority Data
Feb. 13, 2003 (EP) 03100322.1

(51) Int. Cl. G09G 5/00

(52) U.S. Cl. 345/173

(57) ABSTRACT

TFTs (10) within a display device (1) are intentionally made sensitive to radiation from an external light source (12), for example by making a pin-hole (34) in the socalled black-matrix layer (33). The voltage across the pixel (8) or sensing this voltage drop just before refreshing the pixel content during 5 the next refresh cycle, it is possible to distinguish between an intentionally illuminated pixel (8) or pixel patterns (37, 38) and a non-illuminated pixel (8).

The invention relates to an interactive display system comprising at least one display device with a multiple of picture elements and having means for applying driving voltages to said picture elements via thin film transistors.

The invention further relates to a display device and to input means for such an interactive display system. The display device is for instance a (active matrix) liquid crystal display device (AMLCD). Liquid crystal display devices have found widespread use in the computer industry and in handheld devices ranging from mobile telephones and price tags to palm top computers and organizers. Touch sensitive display devices usually use touch sensititive screens in front of the display device. Also the combination with a touching device such as a stylus has found widespread applications, while also a need for ways of providing input via the display screen is felt. In stead of using a stylus direct touching by fingers has been proposed in the art.

Using touch sensititive screens in front of the display device generally adds substantially to the cost of such a touch sensitive display device. Moreover such extra screens, in the case of liquid crystal display device reduce contrast, viewing angle and brightness. Furthermore fingerprints may remain on the screen, which further reduces the visibility of the pictures to be displayed.

It is one of the objects of the present invention to overcome at least partly the above mentioned problems. To this end an interactive display system according to the invention further comprises input means being able to provide electromagnetic radiation, the display device comprising layer patterns which selectively pass said electromagnetic radiation to a semiconductor layer of a thin film transistor (TFT).

Quite contrarily to the usual practice in which the disadvantages of the light sensitivity of the thin film transistors in a TFT—matrix is overcome by introducing a light shield, this light sensitivity is now used in a controlled way, e.g. by providing openings at the area of the thin film transistors or by making the patterns opaque for a given range of wavelengths at the area of the thin film transistors.

The input means, e.g. a laser pointer, may be programmed or be moved by hand to generate different kinds of patterns, e.g. a circle, a cross, an arrow etc. the patterns corresponding to a certain function to be performed by the device (zooming, reset, paging) without touching the device.

Several embodiments of the present invention may be used in AMLCD display devices or other active matrix devices of any given size. In small sized display devices, such as found in e.g. organisers, mobile telephones, palm-tops etc. Advantages of using the light pen over a touch-screen are a.o.:

The AMLCD screen remains free from fingerprints, enhancing visibility.

Since no add-on touch-sensitive screens are necessary the display device has improved contrast, viewing angle and brightness properties. Moreover the costs of purchasing and mounting of touch-screen are saved.

The illuminating device (backlight or sidelight) may operate at a lower power level saving valuable battery power.

Integration into existing AMLCD panels is straightforward, only the non-active top plate needs modification, hence, a short-time-to-market is anticipated.

In medium sized display devices such as for example found in PCs and notebooks, further advantages are e.g.:

The possibility to replace one or more of the mouse, touch-pad, and keyboard, because conventional handwriting may be used for entering data.

The possibility to use the well known double click function, used to execute an given icon function, is maintained. That is, a double click (laser) light pulse feature analog to the double click function can be simply be enabled in using a switch mounted on the (laser) light pen.

In desktop computers the (laser) light pen may help in preventing RSI.

In large sized display devices such as for example used in LCDTVs or other big screens, the advantages of the present invention are a.o.:

Touching of screen which is not desired may be circumvented at very large sizes. The (laser) light pen enables “touching” of the screen by means of light.

Using software driven recognition of the light written patterns, the light pen may act as a remote control.

Implementation of computer control like features (such as zoom functions and function buttons in general) may be added to screens normally only having a display function.

Preferably a personalised (laser) light pen may be used. This not only adds security to any possible application of a display device according to the present invention, but also avoids non-desired disturbance/interference of the on-screen-presented information by third parties. In addition, an additional encryption code may be inserted into the (laser) light pen, enhancing personalisation/security in general.

These and other aspects of the invention are apparent from and will be elucidated with reference to the non-restrictive embodiments as described hereinafter by way of example.

In the drawings:

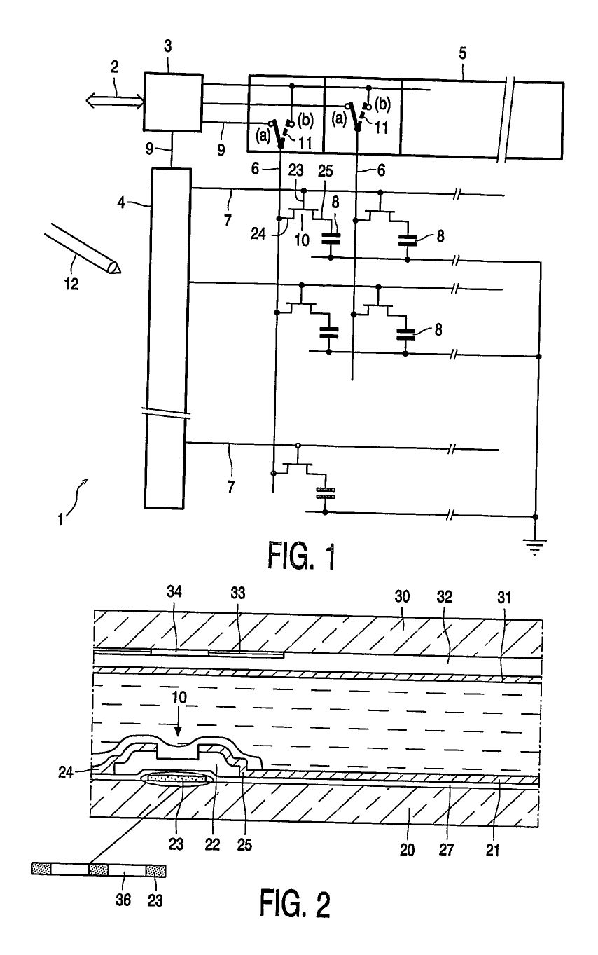

FIG. 1 schematically shows a (liquid crystal) display device according to the invention,

FIG. 2 shows a cross-section of a part of the (liquid crystal) display device, while

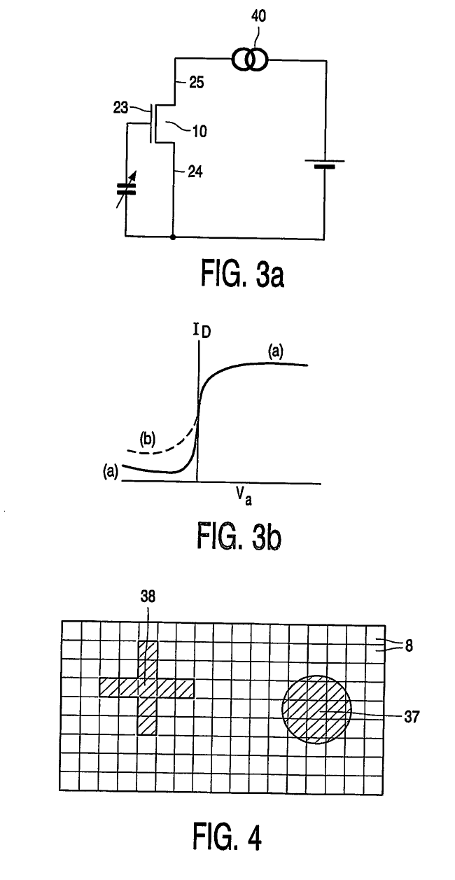

FIG. 3 shows characteristics of the transistors used in the display device according to FIG. 1 and

FIG. 4 shows a plan view of a display device according to the invention

The Figures are diagrammatic and not drawn to scale. Corresponding elements are generally denoted by the same reference numerals.

FIG. 1 is an electric equivalent circuit diagram of a part of a (display) device 1 to which the invention is applicable. It comprises in one possible embodiment a matrix of picture elements or pixels 8 at the areas of crossings of row or selection electrodes 7 and column or data electrodes 6. The row electrodes are consecutively selected by means of a row driver 4, while the column electrodes are provided with data via a data register 5. To this end, incoming data 2 are first processed, if necessary, in a processor 3. Mutual synchronization between the row driver 4 and the data register 5 occurs via drivelines 9.

Signals from the row driver 4 select the picture electrodes via thin-film transistors (TFTs) 10 whose gate electrodes are electrically connected to the row electrodes 7 and the source electrodes are electrically connected to the column electrodes. The signal which is present at the column electrode 6 is transferred via the TFT to a picture electrode of a pixel 8 coupled to the drain electrode. The other picture electrodes are connected to, for example, one (or more) common counter electrode(s). In FIG. 1 only five thin-film transistors (TFTs) 10 have been drawn, simply as an example. The data register 5 also contains switches 11 by which either incoming data can be transferred to the column electrodes 6 (situation 11a), or during a sensing stage, as will be explained later, the status of TFTs 10 can be sensed (situation 1b of the switches 11).

FIG. 2 shows a cross-section of a part of a liquid crystal device having a bottom substrate 20 and an upper substrate 30. The touch sensitive liquid crystal device has picture electrodes 21 on the bottom substrate 20 and a picture electrode 31 on the other substrate 30. The TFTs 10 are realized on the bottom substrate 20 and comprise (in this example), in a generally known way an amorphous silicon layer 22, a gate electrode 23, isolated from the silicon layer 22 by an insulating layer (gate dielectric) 27 and source and drain electrodes 24, 25, which interconnect, dependent on the gate—voltage, the column electrodes to the picture electrodes 21.

The upper substrate 30 further comprises a color filter layer 32 and a so-called black matrix layer 33. The (display) device 1 further comprises an input device 12 to be discussed further on.

The TFT 10 is a three terminal device, consisting of a source electrode, a drain electrode and a gate electrode, see FIG. 3(a). If an appropriate voltage is applied tot the gate electrode 23 of the TFT, charge carrier flow may be stimulated, as shown schematically by the current source 40 in FIG. 3(a).

If a positive voltage is applied to the gate of the TFT electrons will be accumulated in the semi-conductor material just underneath the gate. The accumulated electrons form a conducting channel across the semi-conductor. On one side the semi-conductor may connected at to the source, which may for example be connected to a column. On the other side, the semiconductor may be connected to the drain. In the case that the drain is connected in series with a pixel, towards a common ground, and a conducting channel is present in the semiconductor layer, electric charges may flow from the source to the drain. Thus an individual pixel can be driven. In the off case, a negative voltage is applied to the gate. Thus charges present at the source are isolated from those present at the drain and information at the pixel is maintained. This normal functioning of the TFT 10 is presented by its I_{D}-V_{GD} curve in FIG. 3(b) as a continuous line a.

One further characteristic of semi-conducting materials such as polycrystalline silicon, amorphous silicon or organic semi-conductors is photoelectricity which means, that electron-hole pairs are generated within the material when exposed to light. This induces a photo-induced leakage current in a TFT, which is clearly visible in the off case, which is presented in FIG. 3(b) as a dashed line b. Therefore the TFTs 10 in conventional liquid crystal devices are shielded from any incident light (either ambient light, or intentionally emitted light by backlights or frontlights of liquid crystal devices e.g. by means of the black-matrix layer 33, 34 (FIG. 2). Also the semiconductor layer of the TFT is normally chosen to be as thin as possible in order to minimize the undesired generation of photo-induced current, which can cause the TFT to malfunction.

According to the invention the previously described photoelectric characteristics of the semiconducting materials is intentionally used for application in TFT panels by making the TFTs 10 sensitive to (specific) external light. This can be done by for example making an opening 34 (a pinhole) in the black-matrix layer 33 (FIG. 2) or by replacing the black-matrix material by another material which is made opaque to a given wavelength. For the black-matrix material metal may be used but also PEDOT material may be used.

In the case of an opening 34 (a pinhole) in the black-matrix layer, a (focussed) (laser) light beam from a laser pointer 12 may illuminate a given TFT locally. Thus the charge stored on the capacitor related with the display cell related to said TFT leaks away towards the source, and or gate. Simultaneously, electron-hole pairs are generated on illumination. Because of the charge stored on the capacitor, the electrons and holes are separated, annihilating charges of the opposite sign stored on the capacitor plates. Thus the voltage across the capacitor drops on illumination. In sensing this voltage drop (situation 11b of the switches 11) before writing new information during a next writing cycle, it is possible to distinguish between an intentionally illuminated pixel and a non-illuminated pixel.

The sensed information is stored in processor 3 and by using dedicated software, functions can be assigned to the pattern of the detected illuminated pixels. Detection can be done by integration of a sense amplifier into the data register 5 or in said processor 3. In using dedicated software, function may be assign to the detected pattern. For example, a (filled) circle 37 of illuminated picture elements (pixels), see FIG. 4, may be interpreted as that the content within the (laser) illuminated circle must be enlarged in size, i.e. a contactless and remote zoom-function is introduced. On the other hand the pattern from a laser pointer 12 may be encrypted in such a way that the display only functions in combination with laser pointers providing certain patterns.

Another pattern might be a cross 38. A cross may be interpreted as the reset command, i.e. the zoom function or any other assign function is deactivated. It will be clear that many other patterns used and many other functions may be realised in this way.

In a further embodiment the black-matrix layer 33 is made of a material that is only opaque to radiation of a given range of wavelength, for example 1300-1500 nm. Preferably the materials for the red or green parts of a colour mask, which is often present in the device are used. The advantage of such an opaque layer is that the light sensitive area of the TFT is enlarged, whilst the TFT becomes also more sensitive to non-perpendicular incident light. This may be important for larger sized displays.

The protective scope of the invention is not limited to the embodiments described, while the invention is also applicable to other display devices, for example, (O) LED displays.

It may further be useful to add a second light source as a guide to eye (by means visible light source) in the case that a light source of invisible irradiation to the human eye is used for TFT illumination (opaque films). This can be a frequency doubler in the case of a laser operating in the 1300-1500 nm range.

Although in the example of FIG. 3 a so-called bottom-gate configuration of the TFT 10 has been shown, it will be clear that the invention also is applicable to a top-gate configuration. Radiation sensitivity is obtained now by adaptation of the TFT structure such that it becomes light-sensitive e.g. by providing the gate electrode 23 in FIG. 2 (which now in fact is situated on top of the semiconductor layer) with apertures 36 or by using an all ITO gate electrode.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. An interactive display system comprising at least one display device with a multiple of picture elements and having means for applying driving voltages to said picture elements via thin film transistors, the interactive display system further comprising input means being able to provide electromagnetic radiation, the display device comprising layer patterns which selectively pass said electromagnetic radiation to a semiconductor layer of a thin film transistor.

2. An interactive display system according to claim 1 in which the layer patterns comprise openings at the area of the thin film transistors.

3. An interactive display system according to claim 1 in which the layer patterns are opaque for a given range of wavelengths at the area of the thin film transistors, the input means being able to provide substantially electromagnetic radiation within said range of wavelengths.

4. An interactive display system according to claim 2 in which the layer patterns comprise gate electrodes of the thin film transistors or a black matrix.

5. An interactive display system according to claim 2 which further comprises means for detecting patterns of irradiated thin film transistors.

6. A display device with a multiple of picture elements and having means for applying driving voltages to said picture elements via thin film transistors, the display device comprising layer patterns which selectively pass electromagnetic radiation to a semiconductor layer of a thin film transistors.

7. A display device according to claim 6 in which the layer patterns comprise openings at the area of the thin film transistors.

8. A display device according to claim 6 in which the layer patterns are opaque for a given range of wavelengths at the area of the thin film transistors, the input means being able to provide substantially electromagnetic radiation within said range of wavelengths.

9. A display device according to claim 7 in which the layer patterns comprise gate electrodes of the thin film transistors or a black matrix.

10. Input means for an interactive display system according to claim 1 being able to provide patterns of focussed electromagnetic radiation.

11. Input means according to claim 12 having encryption features.
